(19) United States
(12) Patent Application Publication
(10) Pub. No.: US 2007/0171184 A1
(43) Pub. Date: Jul. 26, 2007

(54) Thin film transistor array panel and liquid crystal display

(76) Inventors: Eun-Hee Han, Seoul (KR); Hee-Seop Kim, Hwasung-si (KR); Jun-Young Lee, Yongin-si (KR); Jun-Woo Lee, Anyang-si (KR); Sung-Wook Kang, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/657,421

(22) Filed: Jan. 23, 2007

(30) Foreign Application Priority Data
Jan. 25, 2006 (KR) 10-2006-0007734

(51) Int. Cl. G09G 3/36

(52) U.S. Cl. 345/103

(57) ABSTRACT

A thin film transistor array panel is disclosed. The thin film transistor array panel includes a gate line formed on a substrate, a gate insulating layer formed on the gate line, a semiconductor layer formed on the gate insulating layer, a data line and a drain electrode formed on the semiconductor layer, a passivation layer formed on the data line and the drain electrode and including a contact hole, and a pixel electrode formed on the passivation layer and connected to the drain electrode through the contact hole. The data line intersects the pixel electrode, and the pixel electrode includes an opening corresponding to a portion of the data line. The opening has a horizontal width that is wider or narrower than the horizontal width of the data line. Thereby, parasitic capacitance that occurs between the data line and the pixel electrode is reduced to improve image quality.

### CROSS-REFERENCE TO RELATED APPLICATION

This application claims priority to and the benefit of Korean Patent Application No. 10-2006-0007734 filed in the Korean Intellectual Property Office on Jan. 25, 2006, the entire contents of which are incorporated herein by reference.

### BACKGROUND OF THE INVENTION

(a) Field of the Invention

The present invention relates to a thin film transistor and a liquid crystal display.

(b) Description of the Related Art

In general, a liquid crystal display includes two display panels having pixel electrodes and a common electrode, and a liquid crystal layer having an anisotropic dielectric interposed therebetween. The pixel electrodes are arranged in a matrix and connected to switching devices such as thin film transistors (TFTs) so as to be sequentially applied with data voltages in units of a pixel row. The common electrode is disposed over the entire surface of the display panel and is applied with a common voltage. In terms of a circuit, the pixel electrode, the common electrode, and the liquid crystal layer interposed therebetween constitute a liquid crystal capacitor. The liquid crystal capacitor together with the switching element connected thereto define a unit of a pixel.

In the LCD, for color display, each pixel uniquely represents one of primary colors (i.e., spatial division) or each pixel sequentially represents the primary colors in turn (i.e., temporal division) such that a spatial or temporal sum of the primary colors is recognized as a desired color. An example of a set of the primary colors includes red, green, and blue colors.

In spatial division, each pixel includes a color filter representing one of the primary colors in an area of the panel facing the pixel electrode. In this case, light from a light source such as light emitting diodes (LEDs), cold cathode fluorescent lamps (CCFLs), etc., may pass through the liquid crystal layer and the color filter, to represent the corresponding colors.

In temporal division, the color display is performed by light sources (LEDs or fluorescent lamps) for red, green, and blue colors representing the primary colors.

When the colors are displayed by temporal division, the light source for the red color lights after scanning for all pixels, the light source for the green color lights after scanning for all pixels again, and then the light source for the blue color lights after scanning for all pixels once more, or each light source for the red color suceesssively lights in a vertical direction according to pixels scanning, each light source for the green color suceesssively lights in a vertical direction according to pixels scanning again, and then each light source for the blue color suceesssively lights in a vertical direction according to pixels scanning once more. Thereby, one frame of about 16.6 ms is divided into three frames (referred to as “sub-frame” hereinafter) for the red, green, and blue colors, respectively, and the scanning for all of pixels is performed three times.

As a result, the period of each sub-frame reduces by one-third with respect to that of one frame, and thereby is about 5.5 ms or less.

Therefore, since it is required that the data voltages are applied to all pixels and the corresponding light source operates for the short period of about 5.5 ms, the scanning speed of the pixels and the operating speed of the light sources become faster by three times or more than those in spatial division. Accordingly, it is a problem that the charged time of the liquid crystal capacitor is reduced, and the problem is more serious as the size of the LCD increases. Moreover, the lighting time of the light sources is also reduced such that the desired color is not obtained.

### SUMMARY OF THE INVENTION

A switching element array panel, according to an embodiment includes a plurality of gate lines formed on a substrate and transmitting gate signals, a plurality of data lines formed on the substrate and intersecting the gate lines, a plurality of pixel electrodes formed on the substrate, a plurality of switching elements electrically connecting the data lines to the pixel electrodes according to the gate signals of the gate lines, and an insulating layer interposed between the data lines and the pixel electrodes. At least one of the data lines intersect the pixel electrode; and at least one of the pixel electrodes include an opening corresponding to a portion overlapping the data line.

The insulating layer may include a first layer made of an inorganic material and a second layer made of an organic material. The opening may be wider than the horizontal width of the data line so that the area of the data line completely covers the area of the opening.

The gate lines may be subdivided into gate line groups that are grouped by a predetermined number of the gate lines electrically connected to each other.

The number of switching elements (Ns) may be determined by the following formula, that is the number of switching elements (Ns)=the number of data lines (Nd)×the number of gate line groups (Ng).

A liquid crystal display according to another embodiment includes a first display panel having a light blocking member formed on a first substrate, a second display panel facing the first display panel and having a plurality of gate lines formed on a second substrate and transmitting gate signals, a plurality of data lines formed on the second substrate and intersecting the gate lines, a plurality of pixel electrodes formed on the second substrate, a plurality of switching elements electrically connecting the data lines to the pixel electrodes according to the gate signals of the gate lines, an insulating layer interposed between the data lines and the pixel electrodes, and a liquid crystal interposed between the first display panel and the second display panel. At least one of the data lines intersect the pixel electrodes and at least one of the pixel electrodes include an opening corresponding to a portion overlapping the data line.

The insulating layer may include a first layer made of an inorganic material and a second layer made of an organic material.

The opening may have a horizontal width that is wider than the horizontal width of the data line.

The light blocking member may be formed on a portion corresponding to the opening.

The light blocking member may have a horizontal width that is wider than the horizontal width of the opening so that the area of the light blocking member completely covers the area of the opening.

The gate lines may be subdivided into gate line groups that are grouped by a predetermined number of gate lines electrically connected to each other.

The number of switching elements (Ns) may be determined by the following formula, that is the number of switching elements (Ns)=the number of data lines (Nd)×the number of gate line groups (Ng).

### BRIEF DESCRIPTION OF THE DRAWINGS

An example of an embodiment will be described in detail with reference to the accompanying drawings for a clear understanding of advantages thereof, wherein:

FIG. 1 is a block diagram of an LCD according to an example of an embodiment;

FIG. 2 is an equivalent circuit diagram of one pixel in the liquid crystal display according to an example of an embodiment;

FIG. 3 is a waveform diagram of gate signals applied to gate lines of an LCD according to an example of an embodiment;

FIG. 4 is a layout view of an LCD according to an example of an embodiment;

FIGS. 5A, 5B, and 5C are cross-sectional views of the LCD taken along lines VA-VA, VB-VB, and VC-VC of FIG. 4, respectively;

FIG. 6 is a layout view of an LCD according to another example of an embodiment; and

FIG. 7 is a cross-sectional view of the LCD taken along lines VII-VII.

### DETAILED DESCRIPTION OF THE EMBODIMENTS

One or more embodiments will be described more fully hereinafter with reference to the accompanying drawings, in which examples of embodiments are shown.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Now, an LCD and a TFT array panel according to an example of an embodiment will be described in detail with reference to the accompanying drawings.

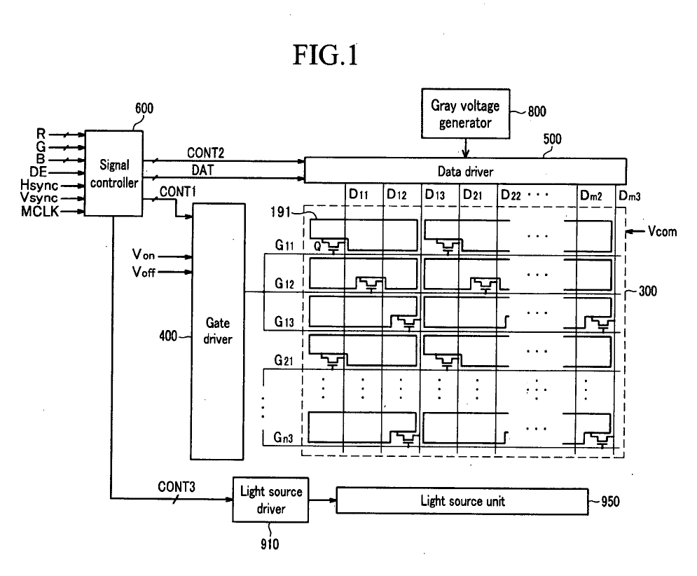

An LCD according to an example of an embodiment will now be described in detail with reference to FIGS. 1 to 3.

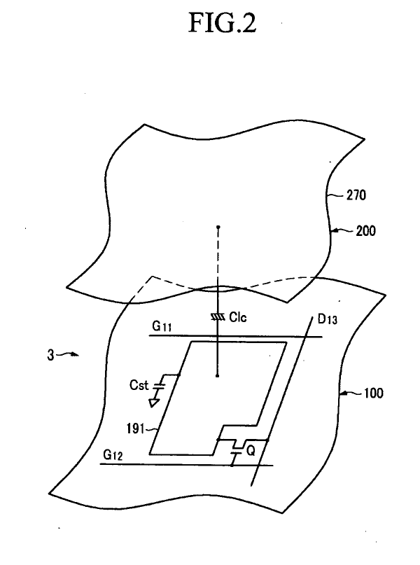

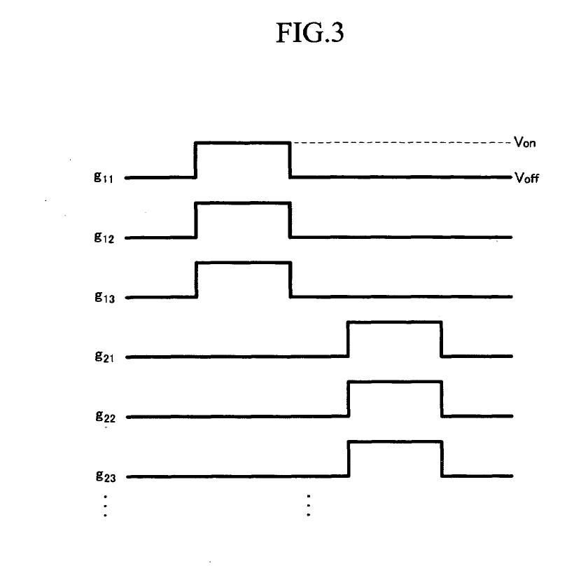

FIG. 1 is a block diagram of an LCD of an example of an embodiment, FIG. 2 is an equivalent circuit diagram of one pixel in the liquid crystal display according to an example of an embodiment, and FIG. 3 is a waveform diagram of gate signals applied to gate lines of an LCD according to an example of an embodiment.

Referring to FIG. 1, an LCD according to an embodiment includes a liquid crystal (LC) panel assembly 300, a gate driver 400 and a data driver 500 that are coupled with the panel assembly 300, a gray voltage generator 800 coupled with the data driver 500, a light source unit 950 emitting light to the LC panel assembly 300, a light source driver 910 connected to the light source unit 950, and a signal controller 600 controlling the above elements.

The panel assembly 300 includes a plurality of signal lines G₁₁, G₁₂, G₁₃, G₂₁, . . . , and Gₙ₃ and D₁₁, D₁₂, D₁₃, D₂₁, . . . , and Dₘ₃ and a plurality of pixels PX connected to the signal lines G₁₁, G₁₂, G₁₃, G₂₁, . . . , and Gₙ₃ and D₁₁, D₁₂, D₁₃, D₂₁, . . . , and Dₘ₃ and arranged substantially in a matrix. In the structural view shown in FIG. 2, the panel assembly 300 includes a TFT array panel 100 and a common electrode panel 200 facing each other, and a LC layer 3 interposed between the panels 100 and 200.

The signal lines include a plurality of gate lines G₁₁, G₁₂, G₁₃, G₂₁, . . . , and Gₙ₃ transmitting gate signals (also referred to as “scanning signals” hereinafter), and a plurality of data lines D₁₁, D₁₂, D₁₃, D₂₁, . . . , and Dₘ₃ transmitting data voltages.

The gate lines G₁₁, G₁₂, G₁₃, G₂₁, . . . , and Gₙ₃ extend substantially in a row direction and substantially parallel to each other. The gate lines G₁₁, G₁₂, G₁₃, G₂₁, . . . , and Gₙ₃ are connected to output terminals of the gate driver 400 by a unit of a gate line group that is grouped by a predetermined number of gate lines, respectively. As shown in FIG. 1, when the predetermined number is three, the first gate line group having three gate lines G₁₁, G₁₂, and G₁₃ is connected to the first output terminal of the gate driver 400, and an n-th gate line group having three gate lines Gₙ₁, Gₙ₂, and Gₙ₃ is connected to the last output terminal of the gate driver 400. In the example of an embodiment, one gate line group has three gate lines, but the number of the gate line may be varied.

The data lines D₁₁, D₁₂, D₁₃, D₂₁, . . . , and Dₘ₃ extend substantially in a column direction and substantially parallel to each other. Portions of the data lines D₁₁, D₁₂, D₁₃, D₂₁, . . . , and Dₘ₃ intersect the pixels.

Referring to FIG. 2, each pixel includes a switching element Q connected to one gate line, for example the second gate line G₁₂ of the first gate line group, and one data line, for example the third data line D₁₃, and an LC capacitor Clc and a storage capacitor Cst that are connected to the switching element Q. The storage capacitor Cst may be omitted.

The switching element Q is disposed on the TFT array panel 100 and it has three terminals, i.e., a control terminal connected to the gate line G₁₂, an input terminal connected to the data line D₁₃, and an output terminal connected to the LC capacitor Clc and the storage capacitor Cst.

The LC capacitor Ckc includes a pixel electrode 191 disposed on the TFT array panel 100 and a common electrode 270 disposed on the common electrode panel 200 as two terminals. The LC layer 3 disposed between the two electrodes 191 and 270 functions as a dielectric of the LC capacitor Clc. The pixel electrode 191 is connected to the switching element Q, and the common electrode 270 is supplied with a common voltage Vcom and covers an entire surface of the common electrode panel 200. Unlike in FIG. 2, the common electrode 270 may be provided on the TFT array panel 100, and at least one of the electrodes 191 and 270 may have a shape of a bar or a stripe.

The storage capacitor Cst is an auxiliary capacitor for the LC capacitor Clc. The storage capacitor Cst includes the pixel electrode 191 and a separate signal line, which is provided on the TFT array panel 100, overlaps the pixel electrode 191 via an insulator, and is supplied with a predetermined voltage such as the common voltage Vcom. Alternatively, the storage capacitor Cst includes the pixel electrode 191 and an adjacent gate line called a previous gate line, which overlaps the pixel electrode 191 via an insulator.

The data lines D₁₁, D₁₂, D₁₃, D₂₁, . . . , and Dₘ₃ are divided into a plurality of data line groups each of which has the predetermined number of data lines, and the connection between each data line of the data line group and the switching element Q is varied depending on the connection between each gate line of the gate line group and the switching element Q. That is, the first data line of one data line group is connected to the switching elements connected to the first gate line of one gate line group, and the second data line is connected to the switching element connected to the second gate line of the gate line group. Accordingly, since the data lines and the switching elements are sequentially connected in this manner, the last data line Dₘ₃ is connected to the switching element connected to the last gate line Gₙ₃.

For the connection of the gate lines and the data lines, the number of gate lines of the gate line group is the same as that of the data lines of the data line group. Thereby, referring to FIG. 1, one gate line group includes three data lines, the first data lines D₁₁, D₂₁, D₃₁, . . . of each data line group are connected to the switching elements Q connected to the first gate lines G₁₁, G₂₁, G₃₁, . . . of each gate line group, respectively, the second data lines D₁₂, D₂₂, D₃₂, . . . of each data line group are connected to the switching elements Q connected to the second gate lines G₁₂, G₂₂, G₃₂, . . . of each gate line group, respectively, and the third data lines D₁₃, D₂₃, D₃₃, . . . of each data line group are connected to the switching elements Q connected to the third gate lines G₁₃, G₂₃,G₃₃, . . . of each gate line group, respectively. In this case, the first and second data lines D₁₁, D₁₂, D₂₁, D₂₂, . . . of three data lines of the respective data line groups intersect the pixel electrodes 191. Alternatively, all the data lines may intersect the pixel electrodes 191, or the remaining data lines except for the first and last data lines of each data line group may intersect the pixel electrodes 191.

In FIG. 1, the switching elements Q are formed on the lower of the pixel electrodes 191, but may be formed on the upper of the pixel electrodes 191. Moreover, the gate lines G₁₁, G₁₂, G₁₃, G₂₁, . . . , and Gₙ₃ are formed on the lower part of the pixel electrodes 191, but may be formed on the upper part of the pixel electrodes 191. Furthermore, the data lines D₁₁, D₁₂, D₁₃, D₂₁, . . . , and Dₘ₃ are disposed on the right of the switching elements Q, but may be disposed on the left of the switching elements Q.

One or more polarizers (not shown) are attached to the panel assembly 300.

Referring to FIG. 1 again, the gray voltage generator 800 generates a full number of gray voltages or a limited number of gray voltages (referred to as “reference gray voltages” hereinafter) related to the transmittance of the pixels. Some of the (reference) gray voltages have a positive polarity relative to the common voltage Vcom, while the other of the (reference) gray voltages have a negative polarity relative to the common voltage Vcom.

The gate driver 400 is connected to the gate lines G₁₁, G₁₂, G₁₃, G₂₁, . . . , and Gₙ₃ of the panel assembly 300, and synthesizes a gate-on voltage Von and a gate-off voltage Voff to generate the gate signals for application to the gate lines G₁₁, G₁₂, G₁₃, G₂₁, . . . , and Gₙ₃. Three gate lines included in the same gate line group are supplied with the same gate signal.

The data driver 500 is connected to the data lines D₁₁, D₁₂, D₁₃, D₂₁, . . . , and Dₘ₃ of the panel assembly 300 and applies data voltages, which are selected from the gray voltages supplied from the gray voltage generator 800, to the data lines D₁₁, D₁₂, D₁₃, D₂₁, . . . , and Dₘ₃. However, when the gray voltage generator 800 generates only a few of the reference gray voltages rather than all the gray voltages, the data driver 500 may divide the reference gray voltages to generate the data voltages among the gray voltages.

The light source unit 950 includes a plurality of light sources that represent the primary colors. The light sources may be LEDs. As described above, the primary colors may be red, green, and blue colors. By making the light sources for the red, green, and blue colors sequentially turn on and off, each pixel sequentially represents the primary colors in turn such that a spatial or temporal sum of the primary colors is recognized as a desired color.

The light source driver 910 controls the light source unit 950.

The signal controller 600 controls the gate driver 400, data driver 500, the light source driver 910, etc.

Each of driving devices 400, 500, 600, 800, and 910 may include at least one integrated circuit (IC) chip mounted on the LC panel assembly 300 or on a flexible printed circuit (FPC) film in a tape carrier package (TCP) type, which are attached to the panel assembly 300. Alternatively, at least one of the driving devices 400, 500, 600, 800, and 910 may be integrated with the panel assembly 300 along with the signal lines G₁₁, G₁₂, G₁₃, G₂₁, . . . , and Gₙ₃ and D₁₁, D₁₂, D₁₃, D₂₁, . . . , and Dₘ₃ and the switching elements Q. As a further alternative, all the driving devices 400, 500, 600, 800, and 910 may be integrated into a single IC chip, but at least one of the driving devices 400, 500, 600, 800, and 910 or at least one circuit element in at least one of the processing units devices 400, 500, 600, 800, and 910 may be disposed out of the single IC chip.

Now, the operation of the above-described LCD will be described in detail.

The signal controller 600 is supplied with input image signals R, G, and B and input control signals for controlling the display thereof from an external graphics controller (not shown). The input image signals R, G, and B contain luminance information of pixels, and the luminance has a predetermined number of grays, for example 1024 (=2¹⁰), 256 (=2⁸), or 64 (=2⁶) grays. The input control signals include a vertical synchronization signal Vsync, a horizontal synchronization signal Hsync, a main clock signal MCLK, and a data enable signal DE.

On the basis of the input control signals and the input image signals R, G, and B, the signal controller 600 generates gate control signals CONT1, data control signals CONT2, and light source control signals CONT3, and it processes the image signals R, G, and B to be suitable for the operation of the panel assembly 300 and the data driver 500. The signal controller 600 sends the gate control signals CONT1 to the gate driver 400, sends the processed image signals DAT and the data control signals CONT2 to the data driver 500, and sends the light source control signals CONT3 to the light source driver 910.

The gate control signals CONT1 include a scanning start signal STV for instructing to start scanning, and at least one clock signal for controlling the output period of the gate-on voltage Von. The gate control signals CONT1 may include an output enable signal OE for defining the duration of the gate-on voltage Von.

The data control signals CONT2 include a horizontal synchronization start signal STH for indicating the start of data transmission for a plurality of pixel rows (referred to as “a pixel row group” hereinafter) connected to one gate line group, a load signal LOAD for instructing to apply the data voltages to the data lines D₁₁, D₁₂, D₁₃, D₂₁, . . . , and Dₘ₃, and a data clock signal HCLK. The data control signal CONT2 may further include an inversion signal. RVS for reversing the polarity of the data voltages (relative to the common voltage Vcom).

The light source control signals CONT3 include a control signal for turning the light sources for red, green, and blue colors on and off at an appropriate time, respectively.

Responsive to the data control signals CONT2 from the signal controller 600, the data driver 500 receives a package of the digital image signals DAT for one pixel row group from the signal controller 600, converts the digital image signals DAT into analog data voltages selected from the gray voltages, and applies the analog data voltages to the data lines D₁₁, D₁₂, D₁₃, D₂₁, . . . , and Dₘ₃.

The gate driver 400 applies the gate-on voltage Von from the first gate line group to the last gate line group in response to the gate control signals CONT1 from the signal controller 600, thereby turning on the switching transistors Q connected to all gate lines G₁₁, G₁₂, G₁₃, G₂₁, . . . , and Gₙ₃. The data voltages applied to the data lines D₁₁, D₁₂, D₁₃, D₂₁, . . . , and Dₘ₃ are then supplied to the pixels through the activated switching transistors Q. As described above, the gate lines included in the same gate line group are supplied with the same gate signal such that, as shown in FIG. 3, the gate lines included in the same gate line group are simultaneously supplied with a gate-on voltage Von.

As described, while the scanning of the gate signals is performed, the light source driver 910 turns each light source of the light source unit 950 on and off depending on the light source control signals CONT3 from the signal controller 600 such that the light sources for red, green, and blue colors are sequentially turned on and off for three sub-frames, respectively. The period of one sub-frame is about one-third of one frame period.

For the first sub-frame of one frame lighting the light sources for a red color, the gate-on voltage Von is sequentially applied from the first gate line group to the last gate line group such that the data voltages corresponding to the image signals R for the red color are applied to the data lines D₁₁, D₁₂, D₁₃, D₂₁, . . . , and Dₘ₃. Then, for the next sub-frame of the frame lighting the light sources for a green color, the gate-on voltage Von is again sequentially applied from the first gate line group to the last gate line group such that the data voltages corresponding to the image signals G for the green color are applied to the data lines D₁₁, D₁₂, D₁₃, D₂₁, . . . , and Dₘ₃. Finally, for the final sub-frame of the frame lighting the light sources for a blue color, the gate-on voltage Von is sequentially applied from the first gate line group to the last gate line group such that the data voltages corresponding to the image signals B for the blue color are applied to the data lines D₁₁, D₁₂, D₁₃, D₂₁, . . . and Dₘ₃. Accordingly, the data voltages for red, green, and blue colors are applied to all pixels, to display an image for a frame.

At this time, since the gate-on voltage Von is simultaneously applied to three gate lines, the gate-on voltage Von applied to each gate line G₁₁, G₁₂, G₁₃, G₂₁, . . . , and Gₙ₃ for one sub-frame is maintained for a horizontal period (also referred to as “1H” and that is equal to one period of the horizontal synchronization signal Hsync and the data enable signal DE). That is, for one frame, the data voltages for red, green, and blue colors corresponding to the image signals R, G, and B are applied for the respective sub-frames in synchronization with the lighting period of the light sources for red, green, and blue colors. However, the total respective charge time with respect to the data voltages for red, green, and blue colors is approximately the same as that in displaying colors by spatial division using the color filters.

The difference between the voltage of a data voltage and the common voltage Vcom applied to a pixel is represented as a voltage across the LC capacitor Clc of the pixel, which is referred to as a pixel voltage. The LC molecules in the LC capacitor Clc have orientations depending on the magnitude of the pixel voltage, and the molecular orientations determine the polarization state of light passing through the LC layer 3. According to the polarization state of the light, transmittance of the light passing through the the polarizer is varied such that the pixel PX has a luminance represented by a gray of the data voltage.

When the next frame starts after one frame finishes, the inversion control signal RVS applied to the data driver 500 is controlled such that the polarity of the data voltages is reversed (which is referred to as “frame inversion”). The inversion signal RVS may be also controlled such that the polarity of the data voltages flowing in a data line is periodically reversed during one frame (for example, row inversion and dot inversion), or the polarity of the data voltages in one packet are reversed (for example, column inversion and dot inversion).

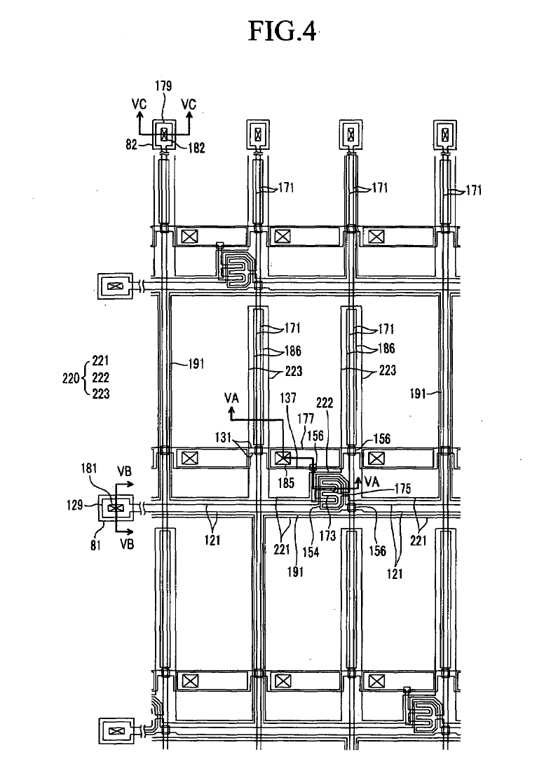

The construction of an LCD according to an example of an embodiment will be described in detail with reference to FIGS. 4 to 7.

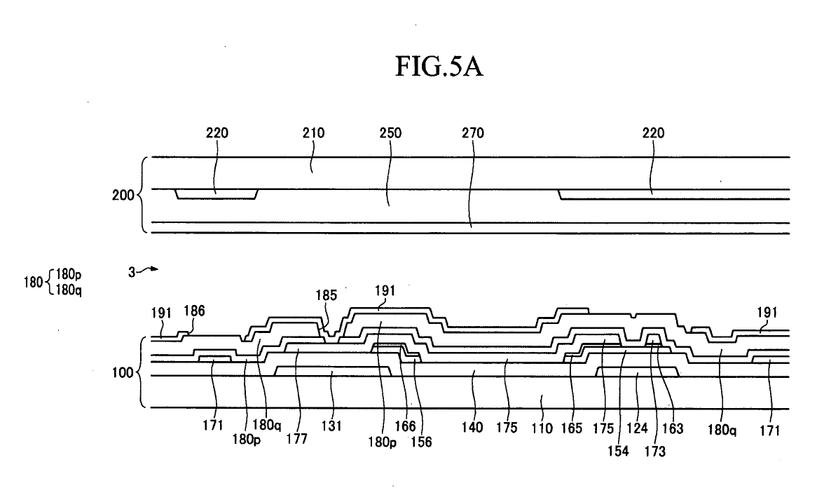

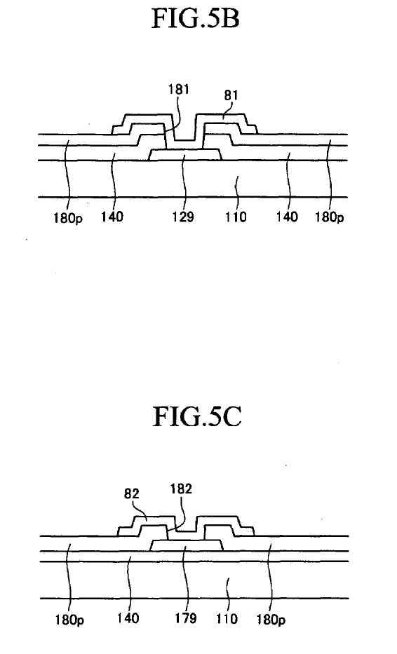

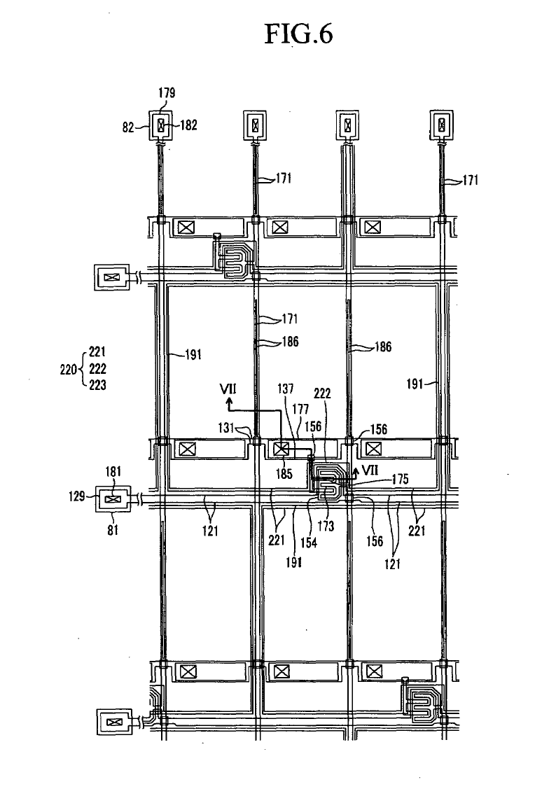

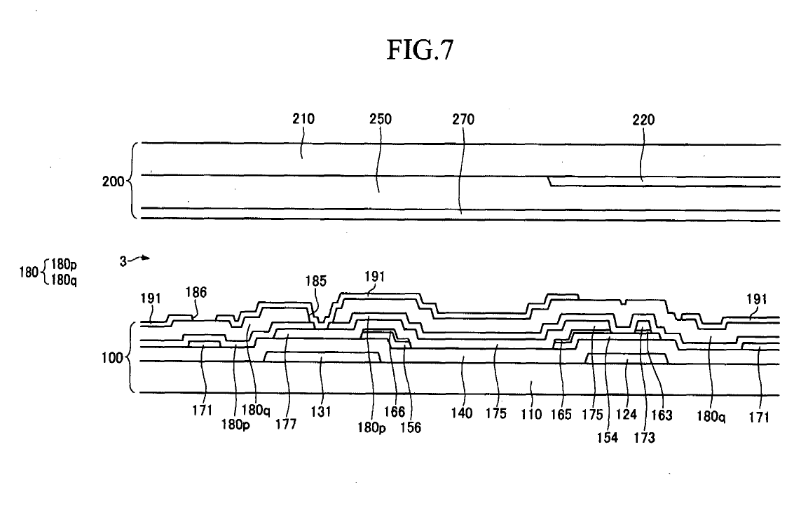

FIG. 4 is a layout view of an LCD according to an example of an embodiment, and FIGS. 5A, 5B, 5C are cross-sectional views of the LCD taken along lines VA-VA, VB-VB, and VC-VC of FIG. 4, respectively. FIG. 6 is a layout view of an LCD according to another embodiment, and FIG. 7 is a cross-sectional view of the LCD taken along lines VII-VII.

Referring to FIGS. 4 to 5C, a TFT array panel 100, a lower panel, will be described.

A plurality of gate lines 121 and a plurality of storage electrode lines 131 are formed on an insulating substrate 110 that is made of such as transparent glass or plastic.

The gate lines 121 transmit gate signals and extend substantially in a transverse direction. Each of the gate lines 121 includes a plurality of gate electrodes 124 projecting upward and an end portion 129 having a large area for contact with another layer or an external driving circuit. A gate driving circuit (not shown) for generating the gate signals may be mounted on a flexible printed circuit (FPC) film (not shown), which may be attached to the substrate 110, directly mounted on the substrate 110, or integrated with the substrate 110. The gate lines 121 may extend to be connected to a driving circuit that may be integrated with the substrate 110.

The storage electrode lines 131 are supplied with a predetermined voltage such as the common voltage Vcom applied to the common electrode 270 of the common so electrode panel 200, and each of the storage electrode lines 131 is substantially parallel to the gate lines 121. Each of the storage electrode lines 131 is disposed between two adjacent gate lines 121, and close to the lower of two adjacent gate lines 121. Each of the storage electrode lines 131 includes an expansion 137 expanding downward. However, the storage electrode lines 131 may have various shapes and arrangements.

The gate lines 121 and the storage electrode lines 131 may be preferably made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ta, and Ti. However, they may have a multi-layered structure including two conductive films (not shown) having different physical characteristics. One of the two films is preferably made of a low resistivity metal such as an Al-containing metal, a Ag-containing metal, and a Cu-containing metal for reducing signal delay or voltage drop. The other film is preferably made of a material such as a Mo-containing metal, Cr, Ta, and Ti, which have good physical, chemical, and electrical contact characteristics with other materials such as indium tin oxide (ITO) and indium zinc oxide (IZO). Good examples of the combination of the two films are a lower Cr film and an upper Al (alloy) film, and a lower Al (alloy) film and an upper Mo (alloy) film. However, the gate lines 121 and the storage electrode lines 131 may be made of various metals or conductors.

The lateral sides of the gate lines 121 and the storage electrode lines 131 are inclined relative to a surface of the substrate 110, and the inclination angle thereof is in a range of from about 30 to 80 degrees.

A gate insulating layer 140 preferably made of silicon nitride (SiNx) or silicon oxide (SiOx) is formed on the gate lines 121 and the storage electrode lines 131.

A plurality of semiconductor islands 154 and 156, preferably made of hydrogenated amorphous silicon (abbreviated to “a-Si”) or polysilicon, are formed on the gate insulating layer 140. The semiconductor islands 154 are disposed on the gate electrodes 124.

A plurality of ohmic contact islands 163, 165, and 166 are formed on the semiconductor islands 154 and 156. The ohmic contacts 163, 165, and 166 are preferably made of n+ hydrogenated a-Si heavily doped with an n-type impurity such as phosphorous, or they may be made of silcide. The ohmic contacts 163 and 165 are located in pairs on the semiconductor islands 154, and the ohmic contacts 166 are located on the semiconductor islands 156.

The lateral sides of the semiconductor islands 154 and 156 and the ohmic contact islands 163, 165, and 166 are inclined relative to the surface of the substrate 110, and the inclination angles thereof are preferably in a range of from about 30 to 80 degrees.

A plurality of data lines 171 and a plurality of drain electrodes 175 are formed on the ohmic contact islands 163, 165, and 166 and the gate insulating layer 140. The data lines 171 transmit data signals and extend substantially in the longitudinal direction to intersect the gate lines 121. Each of the data lines 171 also intersects the storage electrode lines 131. Each data line 171 includes a plurality of source electrodes 173 projecting toward the gate electrodes 124 and an end portion 179 having a large area for contact with another layer or an external driving circuit. A data driving circuit (not shown) for generating the data signals may be mounted on an FPC film (not shown), which may be attached to the substrate 110, directly mounted on the substrate 110, or integrated with the substrate 110. The data lines 171 may extend to be connected to a driving circuit that may be integrated with the substrate 110.

The drain electrodes 175 are separated from the data lines 171 and are disposed opposite the source electrodes 173 with respect to the gate electrodes 124. Each of the drain electrodes 175 includes a wide end portion 177 and a narrow end portion. The wide end portion 177 overlaps an expansion 137 of a storage electrode line 131 and the narrow end portion is partly enclosed by a source electrode 173. The source electrode 173 and the drain electrode 175 have boundaries opposite to each other, and the boundaries meander such that the boundary length in a unit area is elongated.

A gate electrode 124, a source electrode 173, and a drain electrode 175 along with a semiconductor island 154 form a TFT having a channel formed in the semiconductor island 154 disposed between the source electrode 173 and the drain electrode 175. At this time, since the boundaries of the source electrode 173 and the drain electrode 175 meander, the width of the channel increases so that the characteristics of the TFT are improved.

The data lines 171 and the drain electrodes 175 may be made of a refractory metal such as Cr, Mo, Ta, Ti, or alloys thereof. However, they may have a multi-layered structure including a refractory metal film (not shown) and a low resistivity film (not shown). Good examples of the multi-layered structure are a double-layered structure including a lower Cr/Mo (alloy) film and an upper Al (alloy) film, and a triple-layered structure of a lower Mo (alloy) film, an intermediate Al (alloy) film, and an upper Mo (alloy) film. However, the data lines 171 and the drain electrodes 175 may be made of various metals or conductors.

The data lines 171 and the drain electrodes 175 have inclined edge profiles, and the inclination angles thereof are in a range of from about 30 to 80 degrees.

The ohmic contact islands 163, 165, and 166 are interposed only between the underlying semiconductor islands 154 and 156 and the overlying conductors 173 and 175 thereon, and reduce contact resistance therebetween.

The semiconductor islands 156 are disposed on the portions on which the gate lines 121 and the storage electrode lines 131 intersect the data lines 171, or the portions on which the drain electrodes 175 encounter the expansion 137 of storage electrode line 131, and they smooth the profile of the surface to prevent disconnection of the data lines 171.

A passivation layer 180 is formed on the data lines 171, the drain electrodes 175, and the exposed portions of the semiconductor islands 154.

The passivation layer 180 includes a lower passivation film 180p preferably made of an inorganic insulator such as silicon nitride or silicon oxide, and an upper passivation film 180q preferably made of an organic insulator. The organic insulator preferably has a dielectric constant less than about 4.0, and it may have photosensitivity and may provide a flat surface. The upper passivation film 180q is removed on the end portions 129 and 179 of the gate lines 121 and the data lines 171, but it may be formed on the end portions 129 and 179 of the gate lines 121 and the data lines 171. The passivation layer 180 may have a single-layered structure, preferably made of an inorganic or organic insulator.

The passivation layer 180 has a plurality of contact holes 182 and 185 exposing the end portions 179 of the data lines 171 and the drain electrodes 175, respectively. The passivation layer 180 and the gate insulating layer 140 have a plurality of contact holes 181 exposing the end portions 129 of the gate lines 121.

A plurality of pixel electrodes 191 and a plurality of contact assistants 81 and 82 are formed on the passivation layer 180. They may be made of a transparent conductor such as ITO or IZO, or reflective conductor such as Ag, Al, Cr, or alloys thereof.

Each of the pixel electrodes 191 includes openings 186. The openings 186 expose portions of the data line 171 intersecting the pixel electrode 191, that is, the portions overlapping the pixel electrode 191. Thereby, parasitic capacitance between the data line 171 and the overlapping pixel electrode 191 is reduced. The horizontal width of the opening 186 is larger than that of the data line 171.

The pixel electrode 191 may overlap adjacent data lines 171 or gate lines 121, to improve an aperture ratio of the pixel.

The pixel electrodes 191 are physically and electrically connected to the drain electrodes 175 through the contact holes 185 such that the pixel electrodes 191 receive data voltages from the drain electrodes 175. The pixel electrodes 191 supplied with the data voltages generate electric fields in cooperation with a common electrode 270 of the common electrode panel 200 supplied with a common voltage, which determine the orientations of liquid crystal molecules (not shown) of a liquid crystal layer 3 disposed between the two electrodes. A pixel electrode 191 and the common electrode 270 form a capacitor referred to as a “liquid crystal capacitor,” which stores applied voltages after the TFT turns off.

A pixel electrode 191 overlaps a storage electrode line 131. The pixel electrode 191 and a drain electrode 175 electrically connected thereto and the storage electrode line 131 form an additional capacitor referred to as a “storage capacitor,” which enhances the voltage storing capacity of the liquid crystal capacitor.

The contact assistants 81 and 82 are connected to the end portions 129 of the gate lines 121 and the end portions 179 of the data lines 171 through the contact holes 181 and 182, respectively. The contact assistants 81 and 82 respectively protect the end portions 129 and 179 and enhance the adhesion between the end portions 129 and 179 and external devices.

Next, the common electrode panel 200, which is the upper panel, will be described with reference to FIGS. 4 to 5B.

A light blocking member 220 referred to as a black matrix for preventing light leakage is formed on an insulating substrate 210 made of a material such as transparent glass or plastic. The light blocking member 220 includes a transverse portions 221 corresponding to the gate lines 121, protrusions 222 corresponding to the portions of the TFTs, and longitudinal portions 223 corresponding to the openings 186 of the pixel electrodes 191. The longitudinal portions 223 cover the openings 186 of the pixel electrodes 191 as well as the data lines 171 not covered with the pixel electrodes 191. The light blocking member 220 prevents light leakage between the pixel electrodes 191 and defines opening areas facing the pixel electrodes 191.

An overcoat 250 is formed on the substrate 210 and the light blocking member 220. The overcoat 250 is preferably made of an (organic) insulator, and it provides a flat surface. The overcoat 250 may be omitted.

The common electrode 270 is formed on the overcoat 250. The common electrode 270 may be made of a transparent conductive material such as ITO or IZO.

Areas at which an electric field that occurs between the data lines 171 under the openings 186 and the common electrode 270 or the data lines 171 underlying the openings 186 and the pixel electrode 191 adjacent to the data lines 171 is distorted are covered with the longitudinal portions 223 of the light blocking member 220 such that the image deterioration due to the electric field distortion decreases.

An LCD according to another embodiment will be described with reference to FIGS. 6 and 7.

FIG. 6 is a layout view of an LCD according to another embodiment, and FIG. 7 is a cross-sectional view of the LCD taken along lines VII-VII.

The layered structures of the LCD according to this embodiment are almost the same as those shown in FIGS. 4 to 5C.

In a TFT array panel 100, a plurality of gate line 121 including gate electrodes 124 and end portions and a plurality of storage electrode lines 131 including expansions 137 are formed on a substrate 110. A gate insulating layer 140, a plurality of semiconductor islands 154 and 156, and a plurality of ohmic contact islands 163, 165, and 166 are sequentially formed on the gate lines 121 and the storage electrode lines 131. A plurality of data lines 171 including source electrodes 173 and end portions 179, and a plurality of drain electrodes 175, are formed on the ohmic contact islands 163, 165, and 166, and then a passivation layer 180 is formed on the data lines 171 and the drain electrodes 175. The passivation layer 180 and the gate insulating layer 140 include a plurality of contact holes 181, 182, and 185, and a plurality of pixel electrodes 191 including openings 186 and a plurality of contact assistants 81 and 82 are formed on the passivation layer 180.

However, as shown in FIGS. 4 to 5C, in the TFT array panel of this embodiment, the horizontal widths of the openings 186 is narrower than those of the underlying data lines 171.

Next, in a common electrode panel 200 of this embodiment, a light blocking member 220 including transverse portions 221 and protrusions 222 and an overcoat 250 are formed on a substrate 210. However, the horizontal widths of the openings 186 are narrower than those of the data lines 171, and thereby areas at which an electric field that occurs between the data lines 171 under the openings 186 and the common electrode 270 or the data lines 171 underlying the openings 186 and the pixel electrode 191 adjacent to the data lines 171 are distorted are covered with data lines 171 underlying the openings 186. Thereby, longitudinal portions of the light blocking member 220 corresponding to the openings 186 are unnecessary such that the aperture ratio of the pixels increases.

Unlike the embodiments shown in FIGS. 4 to 7, the semiconductors may substantially have the same planner shape as the data lines, the drain electrodes, and the underlying ohmic contacts, except for portions on which the TFTs are formed. That is, the semiconductors may include unexposed portions under the data lines and the drain electrodes and the underlying ohmic contacts, and exposed portions between the source electrodes and the drain electrodes.

When colors are displayed by a plurality of light sources emitting the primary colors such as red, green, and blue colors, etc., the charge time of the data voltages for red, green, and blue colors is not decreased such that image quality of the display device improves.

When at least one data line intersects the pixel electrodes, the pixel electrodes overlapping the data line are removed to form the openings in the pixel electrodes. Thereby, parasitic capacitance that occurs between the pixel electrodes and the data line is reduced to improve image quality of a display device. At this time, when the horizontal widths of the openings are narrower than those of the data lines, portions without the pixel electrodes do not need the light blocking member, which improves the aperture ratio of the display device.

While this invention has been described in connection with what is presently considered to be a practical example of an embodiment, it is to be understood that the invention is not limited to the disclosed embodiments, but, on the contrary, is intended to cover various modifications and equivalent arrangements included within the spirit and scope of the appended claims.

What is claimed is:

1. A switching element array panel comprising:
a plurality of gate lines formed on a substrate and transmitting gate signals;
a plurality of data lines formed on the substrate and intersecting the gate lines;
a plurality of pixel electrodes formed on the substrate;
a plurality of switching elements electrically connecting the data lines to the pixel electrodes according to the gate signals of gate lines; and
an insulating layer interposed between the data lines and the pixel electrodes,
wherein at least one of the data lines intersect the pixel electrode; and at least one of the pixel electrodes include an opening corresponding to a portion overlapping the data line.

2. The switching element array panel of claim 1, wherein the insulating layer comprises a first layer made of an inorganic material and a second layer made of an organic material.

3. The switching element array panel of claim 1, wherein the opening is wider than the horizontal width of the data line so that the area of the data line completely covers the area of the opening.

4. The switching element array panel of claim 1, wherein the gate lines are subdivided into gate line groups that are grouped by a predetermined number of the gate lines electrically connected to each other.

5. The swiching element array panel of claim 4, wherein the number of the switching elements (Ns) is determined by the following formula:
The number of switching elements (Ns)=The number of data lines (Nd)×the number of gate line groups (Ng).

6. A liquid crystal display comprising:
a first display panel having a light blocking member formed on a first substrate;
a second display panel facing the first display panel and having a plurality of gate lines formed on a second substrate and transmitting gate signals, a plurality of data lines formed on the second substrate and intersecting the gate lines, a plurality of pixel electrodes formed on the second substrate, a plurality of switching elements electrically connecting the data lines to the pixel electrodes according to the gate signals of the gate lines, an insulating layer interposed between the data lines and the pixel electrodes; and
a liquid crystal interposed between the first display panel and the second display panel,
wherein at least one of the data lines intersect the pixel electrode and at least one of the pixel electrodes include an opening corresponding to a portion overlapping the data line.

7. The liquid crystal display of claim 6, wherein the insulating layer comprises a first layer made of an inorganic material and a second layer made of an organic material.

8. The liquid crystal display of claim 6, wherein the opening has a horizontal width that is wider than the horizontal width of the data line.

9. The liquid crystal display of claim 8, wherein the light blocking member is formed on a portion corresponding to the opening.

10. The liquid crystal display of claim 9, wherein the light blocking member has a horizontal width that is wider than the horizontal width of the opening so that the area of the light blocking member completely covers the area of the opening.

11. The liquid crystal display of claim 6, wherein the gate lines are subdivided into gate line groups that are grouped by a predetermined number of gate lines electrically connected to each other.

12. The liquid crystal display of claim 11, wherein the number of switching elements (Ns) is determined by the following formula:
The number of switching elements (Ns)=The number of data lines (Nd)×the number of gate line groups (Ng).
